(19) United States
(12) Patent Application Publication
(10) Pub. No.: US 2010/0025324 A1
(43) Pub. Date: Feb. 4, 2010

(54) FILTERING MEDIUM FOR MOLTEN METAL AND METHOD FOR PRODUCING THE SAME

(75) Inventors: Tsuneo Komiyama, Toki-shi (JP); Akito Higuchi, Kani-shi (JP); Hiroyuki Hotta, Kani-shi (JP)

Correspondence Address: BURR & BROWN, PO BOX 7068, SYRACUSE, NY, 13261-7068, US

(73) Assignees: NGK Insulators, Ltd., Nagoya-City (JP); NGK Adrec Co., Ltd., Kani-Gun (JP)

(21) Appl. No.: 12/496,952

(22) Filed: Jul. 2, 2009

(30) Foreign Application Priority Data
Aug. 4, 2008 (JP) 2008-200351

(51) Int. Cl. B01D 29/03; B28B 1/00

(52) U.S. Cl. 210/510.1; 264/42

(57) ABSTRACT

A filtering medium for molten metal which is excellent in inclusion removal performance and durability and further may provide sufficient throughput and a method for producing the same. A filtering medium for molten metal in the present invention includes a two-layered structure of a macropore ceramic layer at the inflow side and a micropore ceramic layer at the outflow side. The average pore diameter of the micropore ceramic layer is from 100 to 500 μm and the average pore diameter of the macropore ceramic layer is 1.1 to 3.0 times as large as that of the micropore ceramic layer. When respective layers are formed of aggregates bonded with an inorganic binder and the inorganic binder has a needle crystal structure with an aspect ratio of 2 to 50, the inside of filtering medium may be contributed to the filtration and the compatibility between inclusion-trapping performance and lifetime may be ensured.

### BACKGROUND OF THE INVENTION

1. Field of the Invention

The present invention relates to a ceramic filtering medium used for filtering molten metal, particularly molten aluminum, and a method for producing the same.

2. Description of the Related Art

A thin plate or foil of aluminium is produced by casting aluminum molten metal into ingots and rolling them. However, if the ingot is contaminated by inclusions such as metal oxides or solid impurities such as minute fragments of refractories contained in aluminum molten metal, pinholes or surface defects may occur in the thin plate, foil, or the like during the process for rolling the ingots to produce such products. To prevent the defects, it is necessary to remove solid impurities from the molten metal.

As described in Japanese Patent Application Laid-Open (JP-A) No. 1985-5828 and Japanese Utility Model Application Publication (JP-Y) No. 1995-23099, solid impurities such as inclusions are removed by filtering aluminum molten metal using a ceramic filtering medium for molten metal. However, when a cake layer is formed at the inflow side of the filtering medium in the process of filtration, inclusions are trapped in the cake layer. Thus, while the reliability of filtration is improved, the pressure drop is increased and a desired throughput is not given.

Therefore, JP-A-1985-5828 discloses a process in which the efficiency of filtration is improved by gradually increasing texture density over the whole thickness direction of a ceramic foam filter. Further, JP-Y-1995-23099 discloses the filtering medium for molten metal produced by stacking at least two of micro pore ceramic layers to form an integrated body via a macropore ceramic layer.

However, in the filtering medium for molten metal described in JP-A-1985-5828, a ceramic foam with a large pore diameter is used as a filter. Therefore, the inclusion removal performance is not sufficient and the quality may not be ensured during the process for rolling the aluminium ingot after filtration to produce the thin plate, foil, or the like. Since the inner wall of the passage in the filter is smooth, it is difficult to reliably trap inclusions. Further, the porosity is high and the mechanical strength is low, and thus the durability is poor when it is used for filtering molten metal such as molten aluminum.

On the other hand, the filtering medium for molten metal described in JP-Y-1995-23099 is more excellent in inclusion removal performance and mechanical strength than the filtering medium for molten metal described in JP-A-1985-5828. Although, a large portion of inclusions in molten metal is filtered by a cake layer formed on the outer surface of the inflow side of the filtering medium, the inflow side of the filtering medium for molten metal disclosed in JP-Y-1995-23099 is a micropore ceramic layer and thus the cake layer is rapidly formed. This leads to an insufficient throughput.

### SUMMARY OF THE INVENTION

In order to solve the conventional problems, an object of the present invention is to provide a filtering medium for molten metal which is excellent in inclusion removal performance and durability and further may provide sufficient throughput, and a method for producing the same.

According to an aspect of the present invention, the filtering medium for molten metal made to achieve the object above includes a two-layered structure of a macropore ceramic layer at the inflow side and a micropore ceramic layer at the outflow side. It is preferable that the average pore diameter of the micropore ceramic layer is from 100 to 500 μm and the average pore diameter of the macropore ceramic layer is 1.1 to 3.0 times as much as that of the micropore ceramic layer. It is preferable that the maximum pore diameter of the micropore ceramic layer is from 200 to 600 μm and the maximum pore diameter of the macropore ceramic layer is 1.1 to 3.0 times as large as that of the micropore ceramic layer.

It is preferable that both the macropore ceramic layer and the micropore ceramic layer are formed of aggregates bonded with an inorganic binder and the inorganic binder has a needle crystal structure with an aspect ratio of 2 to 50. It is preferable that the inorganic binder is aluminium borate.

It is preferable that the total wall thickness of the macropore ceramic layer and the micropore ceramic layer is from 10 to 25 mm. It is preferable that the ratio of the wall thickness of the macropore ceramic layer to the micropore ceramic layer is from 1:7 to 3:1.

According to another aspect of the present invention, the method for producing the filtering medium for molten metal, includes: kneading a coarse-grained aggregate constituting the macropore ceramic layer and a fine-grained aggregate constituting the micropore ceramic layer with the inorganic binder respectively and then molding and firing them; forming a two-layered structure of a macropore ceramic layer at the inflow side and a micropore ceramic layer at the outflow side; and precipitating needle crystal in particles of these aggregates.

Since the filtering medium for molten metal of the present invention has a two-layered structure of a macropore ceramic layer at the inflow side and a micropore ceramic layer at the outflow side, it is difficult to form a dense cake layer at the inflow side and the molten metal is filtered from the inside of the filtering medium. That is, sufficient throughput may be provided while high inclusion removal performance may be maintained by allowing the inside of the filtering medium which has not conventionally functioned to contribute to the filtration. Since the filtering medium for molten metal is formed of the ceramic layer, it has a sufficient strength.

The filtering medium for molten metal has a large pore diameter. Also, the inorganic binder which bonds ceramic aggregates has a function to trap inclusions in the molten metal. Particularly, when the inorganic binder has a needle crystal structure with an aspect ratio of 2 to 50, inclusions (30 μm or more) which cause pinholes or surface defects may be reliably removed from aluminum molten metal during rolling ingots after the filtration to produce a thin plate, foil, or the like.

In this regard, such a filtering medium for molten metal may be produced by the method including: kneading a coarse-grained aggregate constituting the macropore ceramic layer and a fine-grained aggregate constituting the micropore ceramic layer with the inorganic binder respectively and then molding and firing them; forming a two-layered structure of a macropore ceramic layer at the inflow side and a micropore ceramic layer at the outflow side; and precipitating needle crystal in particles of these aggregates.

### BRIEF DESCRIPTION OF THE DRAWINGS

FIG. 1 is a perspective view conceptually showing the filtering medium for molten metal of the present invention; and

FIG. 2 is a cross-sectional view conceptually showing the filtering medium for molten metal of the present invention.

### DESCRIPTION OF THE PREFERRED EMBODIMENTS

Hereinafter, preferred embodiments of the present invention will be described.

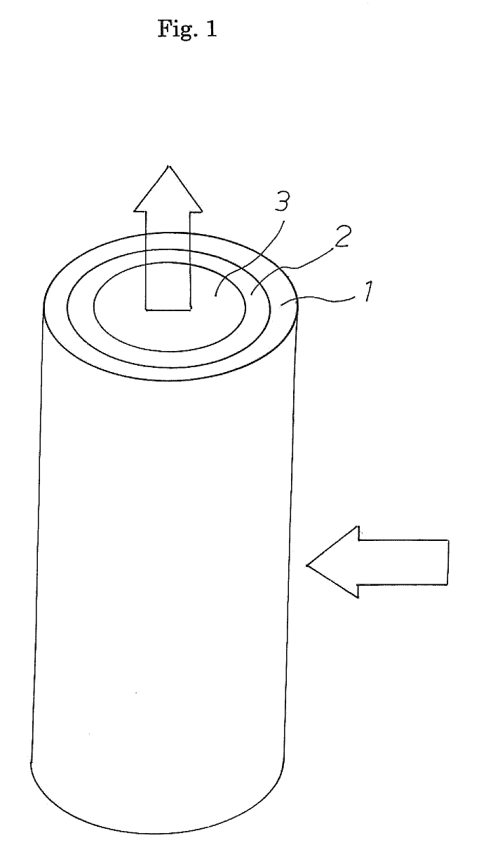

FIG. 1 is a schematic diagram of a filtering medium for molten metal of the present invention. The filtering medium for molten metal with a cylindrical shape is shown herein and the shape may be a plate shape. A macropore ceramic layer 1 at the inflow side is located at an outer circumference and a micropore ceramic layer 2 at the outflow side is located at an inner circumference. The filtering medium for molten metal of the present invention has the two-layered structure. For example, it is soaked in aluminum molten metal at 800 to 900° C. before use. The molten metal flows in from the outer circumferential surface to the inner circumferential surface and then the filtered molten metal is taken out from a central hole 3. In this regard, the molten metal is not particularly limited to the aluminum molten metal. The present invention may be applied to the molten metal with a relatively low melting point, for example, zinc molten metal.

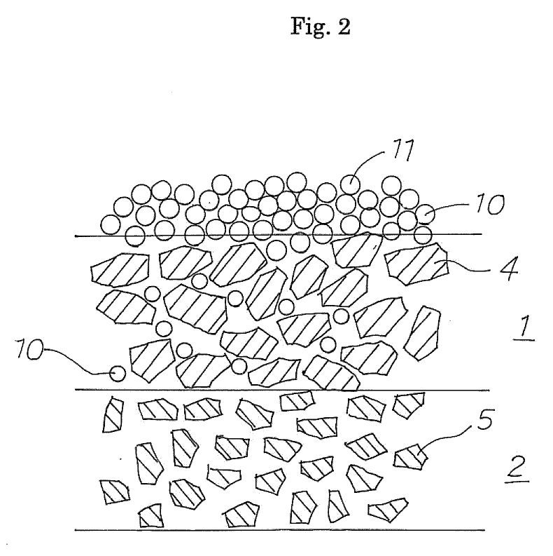

FIG. 2 is a cross-sectional view conceptually showing the filtering medium for molten metal of the present invention. A macropore ceramic layer 1 consists of ceramic aggregates 4 having a relatively large diameter. A micropore ceramic layer 2 consists of ceramic aggregates 5 having a relatively small diameter. The composition of ceramics is not particularly limited. When aluminum molten metal is filtered, a material such as alumina which cannot be eroded by aluminum molten metal may be used.

It is preferable that the average pore diameter of the micropore ceramic layer 2 is in the range of 100 to 500 μm and the average pore diameter of the macropore ceramic layer 1 is 1.1 to 3.0 times as large as that of the micropore ceramic layer 2. These average pore diameters are values determined by the line intercept method. As for the measuring method used herein, a sample which was polished and adjusted for electron microscopic observation was observed in 35 times magnified field, measuring lines were drawn at intervals of 200 μm in the thickness direction, the length of pore portion on the lines was measured, and the average of the total measured length was defined as the average pore diameter. Although the mercury intrusion technique is regularly used as a method for measuring the average pore diameter, the measurement accuracy is reduced when the average pore diameter exceeds 300 μm. Therefore, the line intercept method was employed in the present invention.

The reason why the average pore diameter of the micropore ceramic layer 2 is in the range of 100 to 500 μm is as follows: the pore is easily blocked when the average pore diameter is smaller than the range while the inclusion trapping capacity is reduced when the average pore diameter is larger than the range. Further, the reason why the average pore diameter of the macropore ceramic layer 1 is 1.1 to 3.0 times as large as that of the micropore ceramic layer 2 is as follows: the whole layer is substantially similar to the structure formed of only the micropore ceramic layer 2 when the average pore diameter is smaller than the range. Thus, the effect of the present invention which allows the inside of filtering medium to contribute to the filtration becomes insufficient. On the other hand, the molten metal just passes through the macropore ceramic layer 1 when the average pore diameter exceeds the range. Thus, the formation of the two-layer structure becomes meaningless.

Further, it is preferable that the maximum pore diameter of the micropore ceramic layer 2 is in the range of 200 to 600 μm and the maximum pore diameter of the macropore ceramic layer 1 is 1.1 to 3.0 as large as that of the micropore ceramic layer 2. These maximum pore diameters are values determined by the bubble point method defined by JIS. The bubble point method is a method in which the pore diameter is calculated from the pressure difference when an air pressure is applied from one side of a sample in water and then air bubbles are generated from the opposite side.

The reason why the maximum pore diameter of the micropore ceramic layer 2 is from 200 to 600 μm is as follows: it is difficult to make the maximum pore diameter less than 200 μm when the average pore diameter is in the range of 100 to 500 μm. When the maximum pore diameter exceeds 600 μm, the possibility that inclusions pass through is increased. The reason why the maximum pore diameter of the macropore ceramic layer 1 is 1.1 to 3.0 times as large as that of the micropore ceramic layer 2 is as follows: in the same manner as described above, when the maximum pore diameter is less than the range, the effect of the present invention which allows the inside of filtering medium to contribute to the filtration becomes insufficient. On the other hand, when the maximum pore diameter exceeds the range, the formation of the two-layer structure becomes meaningless.

The average pore diameters and the maximum pore diameters may be controlled by the particle diameters of the ceramic aggregates 4 and 5 which form respective layers. The average particle diameter of all aggregates is within the range of 500 to 2000 μm.

The ceramic aggregates 4 and 5 are bonded with the inorganic binder. It is preferable to use the inorganic binder which has a needle crystal structure with an aspect ratio of 2 to 50. Particularly, when the filtration of aluminum molten metal is intended, it is preferable to use aluminium borate excellent in corrosion resistance against aluminum molten metal. When such an inorganic binder with the needle crystal structure is used, needle crystal are protruded into a molten metal passage between the ceramic aggregates and the capability of trapping fine inclusions contained in molten metal is significantly improved. In addition, the crystalline substance is formed and thus the strength of each layer is increased to 3 MPa or more. Even if it is used for filtering the molten metal, the risk of breakage decreases. In this regard, when a filtering medium with a low strength is damaged, molten metal directly passes through the damaged portion, which involves the risk of flowing out inclusions.

It is preferable that the total thickness of the macropore ceramic layer 1 and the micropore ceramic layer 2 is from 10 to 25 mm. When the total thickness is smaller than the range, the characteristic of the present invention which allows the inside of filtering medium to contribute to the filtration may not be sufficiently exhibited. On the other hand, when the total thickness is larger than the range, the filtration resistance becomes larger. In addition, it is preferable that the ratio of the wall thickness of the macropore ceramic layer 1 to the micropore ceramic layer 2 is from 1:7 to 3:1.

Various examples of the method for producing the filtering medium for molten metal with such a two-layered structure include a method for molding the macropore ceramic layer 1 and the micropore ceramic layer 2 simultaneously or continuously, a method including molding respective layers separately, stacking them after drying, and firing them to form an integrated body, a method including molding respective layers separately, drying and firing them, and stacking them to form an integrated body. Usable examples of the molding method include known molding methods such as ramming, pressing, casting, gel-casting, or centrifugal adhesion. In this regard, an interface between the macropore ceramic layer 1 and the micropore ceramic layer 2 does not necessarily need to be clear and the particle diameter may be gradually changed.

The filtering medium for molten metal of the present invention having such a structure removes inclusions by allowing the molten metal to pass through from the side of the macropore ceramic layer 1 to the side of the micropore ceramic layer 2. As shown in FIG. 2, inclusion particles 10 in the molten metal forms a cake layer 11 on the surface of the macropore ceramic layer 1. However, the cake layer is not dense because the inflow side is the macropore ceramic layer 1. Some of the inclusion particles 10 enter into the inside of the macropore ceramic layer land they are trapped. Therefore, rapid clogging does not occur and a large throughput may be obtained. Additionally, the inclusion particles 10 may be reliably trapped.

When the filtering medium for molten metal has a single layer structure consisting only of the macropore ceramic layer 1, the inclusion particles 10 can pass through. On the other hand, when the filtering medium for molten metal has a single layer structure consisting only of the micropore ceramic layer 2, a dense cake layer is formed at the inflow side, which causes clogging. Consequently, both cases are not preferable.

### EXAMPLES

Hereinafter, Examples and Comparative examples of the present invention will be described.

Table 1 shows the result in which the wall thickness had a constant thickness of 25 mm, the pore diameter of the macropore ceramic layer (shown as a macropore layer) and the micropore ceramic layer (shown as a micropore layer) was changed, and the inclusion-trapping performance and lifetime in aluminum molten metal were evaluated. In any of the embodiments, raw materials were mixed so as to include 8 to 20% by mass of inorganic binder, 1 to 2% by mass of forming binder, 5 to 7% by mass of water, the balance being aggregate. Each layer was continuously molded to form a molded body with a predetermined shape. Then, the molded body was dried, followed by heating to 1200 to 1400° C. to melt the binder. Thereafter, the binder was crystallized by cooling to 800° C. at a cooling rate of 30 to 70° C./hr. As a result, a base material in which aggregate particles were connected by the binder in a state that pores were formed between aggregate particles was produced. It is preferable to use the binder that contains 15 to 80% by mass of boron oxide, 2 to 60% by mass of alumina, and 5 to 50% by mass of magnesium oxide. Further, silica and calcium oxide ray be included in the binder at a rate of 25% by mass or less and 30% by mass or less, respectively. This is because the binder and aluminum molten metal are easily wet and the impregnating performance in the early stage of filtration is improved. Additionally, the above-described composition of boron oxide, alumina, magnesium oxide, and calcium oxide allows the binder to melt at 1200 to 1400° C. and subsequent crystallization is properly performed, which is preferable.

Each sample was formed into a tube shape with an outer diameter of 100 mm, an inner diameter of 75 mm, and a length of 100 mm. Each one was placed one by one in a test furnace and aluminum molten metal was filtered. The point where the head difference was increased to 200 mm was defined as lifetime. The case where the amount of the aluminum molten metal passed through was at least 1.5 times higher than that of the conventional product was evaluated as ⊚. The case where the amount of the aluminum molten metal passed through was 1.1 to 1.5 times as much as that of the conventional product was evaluated as ◯. The case where the amount of the aluminum molten metal passed through was less than the above-described values was evaluated as X. The amount of three oxidative products of alumina (Al₂O₃), spinel (MgAl₂O₄), and magnesia (MgO) (i.e., major inclusions in aluminium specimens before and after the filtration) was analyzed by the Br-methanol method (method for dissolving specimens in a bromine methanol solution and quantitatively analyzing the amount of oxidative products in the dissolution residue) The case where the analyzed amount was at least 1.0 times higher than that of the conventional product was evaluated as ◯. The case where the analyzed amount was 0.8 to 1.0 times as much as that of the conventional product was evaluated as Δ. The case where the analyzed amount was inferior to the above-described values was evaluated as X.

TABLE 1

| | | | | | | Comparative | Comparative | Comparative | Comparative |
|---|---|---|---|---|---|---|---|---|---|
| | | Example 1 | Example 2 | Example 3 | Example 4 | example 1 | example 2 | example 3 | example 4 |
| Average pore | Macropore | 110 | 275 | 550 | 750 | 270 | 1560 | 250 | 800 |
| diameter | layer | | | | | | | | |
| μm | Micropore | 100 | 250 | 500 | 250 | 90 | 520 | 250 | 250 |
| | layer | | | | | | | | |
| | Macropore/ | 110% | 110% | 110% | 300% | 300% | 300% | 100% | 320% |
| | micropore % | | | | | | | | |
| Maximum pore | Macropore | 220 | 330 | 660 | 900 | 320 | 1700 | 300 | 1000 |
| diameter | layer | | | | | | | | |
| μm | Micropore | 200 | 300 | 600 | 300 | 100 | 600 | 300 | 300 |
| | layer | | | | | | | | |
| | Macropore/ | 110% | 110% | 110% | 300% | 320% | 283% | 100% | 333% |
| | micropore % | | | | | | | | |
| Average | Macropore | 600 | 850 | 1400 | 1600 | 850 | 3000 | 750 | 1620 |
| particle | layer | | | | | | | | |
| diameter of | Micropore | 500 | 750 | 1300 | 750 | 450 | 1300 | 750 | 750 |
| aggregates | layer | | | | | | | | |
| μm | | | | | | | | | |
| Wall thickness mm | | 25 | 25 | 25 | 25 | 25 | 25 | 25 | 25 |
| Evaluation | Trapping | ◯ | ◯ | ◯ | ◯ | ◯ | X | ◯ | ◯ |
| results | performance | | | | | | | | |
| | Lifetime | ◯ | ◯ | ◯ | ◯ | X | ◯ | X | X |

Table 2 shows the result in which the average pore diameter remained constant in size and the wall thickness and shape were changed and then the evaluation was carried out in the same manner as described above.

TABLE 2

| | | Example 5 | Example 6 | Example 7 | Example 8 | Example 9 | Example 10 | Example 11 | Example 12 |
|---|---|---|---|---|---|---|---|---|---|
| Average | Macropore | 750 | 750 | 750 | 750 | 750 | 750 | 750 | 750 |
| pore | layer | | | | | | | | |
| diameter | Micropore layer | 250 | 250 | 250 | 250 | 250 | 250 | 250 | 250 |
| μm | | | | | | | | | |
| Wall | Total | 25 | 20 | 15 | 25 | 20 | 15 | 20 | 20 |
| thickness | Thickness of | 3.1 | 2.5 | 1.9 | 18.8 | 15 | 11.3 | 10.0 | 10.0 |
| mm | macropore | | | | | | | | |
| | layer | | | | | | | | |
| | Thickness | 21.9 | 17.5 | 13.1 | 6.3 | 5 | 3.8 | 10.0 | 10.0 |
| | of micropore layer | | | | | | | | |
| | Thickness of | 1 | 1 | 1 | 3 | 3 | 3 | 1 | 1 |
| | macropore layer | | | | | | | | |
| | . . . | . . . | . . . | . . . | . . . | . . . | . . . | . . . | . . . |
| | Thickness | 7 | 7 | 7 | 1 | 1 | 1 | 1 | 1 |
| | of micropore layer | | | | | | | | |
| Shape | | Pipe | Pipe | Pipe | Pipe | Pipe | Pipe | Pipe | Plate |
| Evaluation | Trapping | ◯ | ◯ | ◯ | ◯ | ◯ | ◯ | ◯ | ◯ |
| results | performance | | | | | | | | |
| | Lifetime | ◯ | ◯ | ◯ | ◯ | ◯ | ◯ | ◯ | ◯ |

| | | Comparative | Comparative | Comparative | Comparative | Comparative |
|---|---|---|---|---|---|---|
| | | example 5 | example 6 | example 7 | example 8 | example 9 |
| Average | Macropore | 750 | 750 | 750 | 750 | 750 |
| pore | layer | | | | | |
| diameter | Micropore layer | 250 | 250 | 250 | 250 | 250 |
| μm | | | | | | |
| Wall | Total | 30 | 10 | 20 | 20 | 20 |
| thickness | Thickness of | 15.0 | 5.0 | 16.0 | 2.2 | 16.0 |
| mm | macropore | | | | | |
| | layer | | | | | |
| | Thickness | 15.0 | 5.0 | 4.0 | 17.8 | 4.0 |
| | of micropore layer | | | | | |
| | Thickness of | 1 | 1 | 4 | 1 | 4 |
| | macropore layer | | | | | |
| | . . . | . . . | . . . | . . . | . . . | . . . |
| | Thickness | 1 | 1 | 1 | 8 | 1 |
| | of micropore layer | | | | | |
| Shape | | Pipe | Pipe | Pipe | Pipe | Plate |
| Evaluation | Trapping | ◯ | Δ | Δ | Impossible | Δ |
| results | performance | | | | to mold | |
| | Lifetime | Δ | ◯ | ◯ | | ◯ |

Table 3 shows the result in which the aspect ratio of the inorganic binder was changed and then the evaluation was carried out in the same manner as described above.

TABLE 3

| | | Example | Example | Comparative | Comparative |
|---|---|---|---|---|---|
| | | 13 | 14 | example 9 | example 10 |
| Average pore | Macropore layer | 750 | 750 | 750 | 750 |
| diameter μm | Micropore layer | 250 | 250 | 250 | 250 |
| Wall thickness mm | | 25 | 25 | 25 | 25 |
| Aspect ratio of a needle crystal | | 50 | 2 | 55 | 1.5 |
| structure | | | | | |
| Strength MPa | | 6 | 3 | 8 | 2.5 |
| Evaluation | Trapping | ◯ | ◯ | ◯ | Impossible |
| results | performance | | | | to keep the |
| | Lifetime | ◯ | ◯ | X | shape |

As is apparent from Examples, the filtering medium for molten metal of the present invention has the advantage of being able to ensure the compatibility between inclusion-trapping performance and lifetime (throughput of the molten metal).

What is claimed is:

1. A filtering medium for molten metal, comprising: a two-layered structure of a macropore ceramic layer at the inflow side; and a micropore ceramic layer at the outflow side.

2. The filtering medium for molten metal according to claim 1, wherein the average pore diameter of the micropore ceramic layer is from 100 to 500 μm and the average pore diameter of the macropore ceramic layer is 1.1 to 3.0 times as large as that of the micropore ceramic layer.

3. The filtering medium for molten metal according to claim 2, wherein the maximum pore diameter of the micropore ceramic layer is from 200 to 600 μm and the maximum pore diameter of the macropore ceramic layer is 1.1 to 3.0 times as large as that of the micropore ceramic layer.

4. The filtering medium for molten metal according to claim 1, wherein the macropore ceramic layer and the micropore ceramic layer are formed of aggregates bonded with an inorganic binder and the inorganic binder has a needle crystal structure with an aspect ratio of 2 to 50.

5. The filtering medium for molten metal according to claim 4, wherein the inorganic binder is aluminium borate.

6. The filtering medium for molten metal according to claim 1, wherein the total wall thickness of the macropore ceramic layer and the micropore ceramic layer is from 10 to 25 mm.

7. The filtering medium for molten metal according to claim 1, wherein the ratio of the wall thickness of the macropore ceramic layer to the micropore ceramic layer is from 1:7 to 3:1.

8. A method for producing the filtering medium for molten metal, comprising:
kneading a coarse-grained aggregate constituting the macropore ceramic layer and a fine-grained aggregate constituting the micropore ceramic layer with the inorganic binder respectively and then molding and firing them;
forming a two-layered structure of a macropore ceramic layer at the inflow side and a micropore ceramic layer at the out flow side; and
precipitating needle crystal in particles of these aggregates.
